(19) United States
(12) Patent Application Publication
(10) Pub. No.: US 2014/0075400 A1
(43) Pub. Date: Mar. 13, 2014

(54) READ-CHANNEL DESIGN AND SIMULATION TOOL HAVING A CODEWORD-CLASSIFICATION MODULE

(71) Applicant: LSI CORPORATION, San Jose, CA (US)

(72) Inventors: Pavel Aleksandrovich Aliseychik, Moscow (RU); Aleksey Alexandrovich Letunovskiy, Tokarevka (RU); Alexander Nikolaevich Filippov, Moscow (RU); Ivan Leonidovich Mazurenko, Khimki (RU); Denis Vladimirovich Parkhomenko, Moscow (RU)

(73) Assignee: LSI CORPORATION, San Jose, CA (US)

(21) Appl. No.: 13/864,841

(22) Filed: Apr. 17, 2013

(30) Foreign Application Priority Data
Sep. 12, 2012 (RU) 2012139074

(51) Int. Cl. G06F 17/50

(52) U.S. Cl. CPC G06F 17/5009
USPC 716/101

(57) ABSTRACT

A computer-aided design method for developing, simulating, and testing a read-channel architecture to be implemented in a VLSI circuit. The method uses codeword/waveform classification to accelerate simulation of the read-channel's error-rate characteristics, with said classification being generated using a first read-channel simulator having a limited functionality. A second read-channel simulator having an extended functionality is then run only for some of the codewords, with the latter having been identified based on said codeword/waveform classification. The acceleration is achieved, at least in part, because the relatively highly time-consuming processing steps implemented in the second read-channel simulator are applied to fewer codewords than otherwise required by conventional simulation methods.

The size and complexity of very large-scale integrated (VLSI) circuits preclude manual design. Developers of VLSI circuits typically use specialized software tools in a workstation-based interactive environment. The computer-aided design flow usually includes a structured sequence of steps, beginning with the specification entry and ending with the generation of a database that enables the fabrication facility to fabricate, test, and program the resulting VLSI circuit. Multiple passes may be necessary through all or part of the computer-aided design flow before the corresponding database can be finalized for the fabrication facility.

As used in the relevant art, the term “read channel” refers to the circuitry that performs processing and decoding, such as turbo decoding, of the signals generated by a sensor, such as a magnetic read head, when accessing a corresponding storage medium, such as a magnetic disk platter. A read channel is typically implemented using one or more VLSI circuits. The development, design, simulation, refinement, and testing of a read-channel chip usually involves evaluation of a relatively large number of different turbo-decoders, e.g., based on their respective sector-failure rates (SFRs), bit-error rates (BERs), or other suitable error-rate measures.

In modern data-storage systems, error rates can be extremely low, such as 10⁻¹⁰ or lower in terms of the BER. At these error rates, meaningful characterization of the read channel with conventional design and simulation tools requires a relatively large number of simulations and/or relatively long simulation runs, which can take from several weeks to several months to complete even on multiprocessor clusters. Acceleration of this process is therefore desirable.

Disclosed herein are various embodiments of a computer-aided design method for developing, simulating, and testing a read-channel architecture to be implemented in a VLSI circuit. The method uses codeword/waveform classification to accelerate simulation of the read-channel's error-rate characteristics, with said classification being generated using a first read-channel simulator having a limited functionality. A second read-channel simulator having an extended functionality is then run only for some of the codewords, with the latter having been identified based on said codeword/waveform classification. The acceleration is achieved, at least in part, because the relatively highly time-consuming processing steps implemented in the second read-channel simulator are applied to fewer codewords than otherwise required by conventional simulation methods.

Some of the disclosed embodiments include integrated circuits fabricated based on the simulation and test results obtained using the above-mentioned computer-aided design method for developing, simulating, and testing a read-channel architecture.

The following acronyms/abbreviations are used in the description of embodiments and in the accompanying drawings:
ADC Analog-to-Digital Converter;
ADFE Analog-to-Digital Front End;
ARM Advanced RISC (reduced instruction-set code) Machine;
ASIC Application-Specific Integrated Circuit;
BER Bit-Error Rate;
CTF Continuous-Time Filter;
DBE Digital Back End;
DPLL Digital Phase-Lock Loop;
DPP Decoding and Post-Processing;
DSP Digital Signal Processor;
FPGA Field-Programmable Gate Array;
ISI Inter-Symbol Interference;
LDPC Low-Density Parity-Check;
LLR Log-Likelihood Ratio;
MLSE Maximum-Likelihood Sequence Estimation;
NP-FIR Noise-Predictive Finite-Impulse Response;
RAM Random Access Memory;
ROM Read-Only Memory;
SFR Sector-Failure Rate;
SNR Signal-to-Noise Ratio;
VLSI Very-Large-Scale Integration.

In the accompanying drawings:

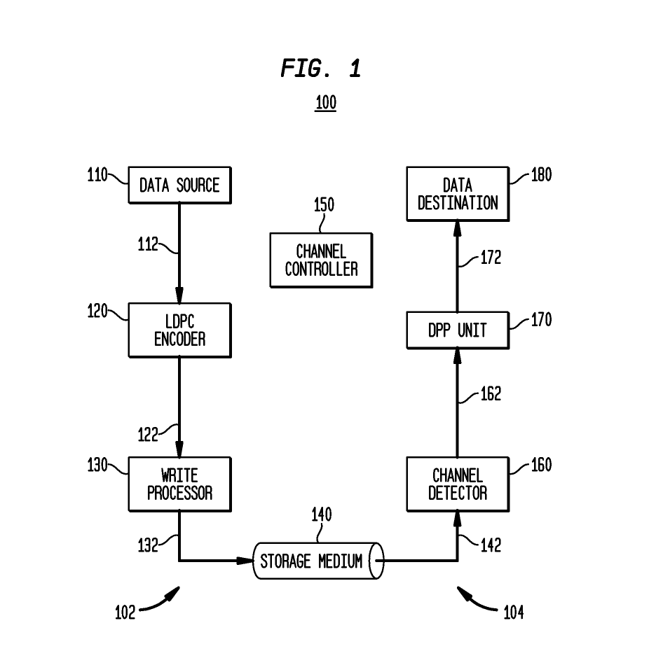

FIG. 1 shows a block diagram of a communication system having a read channel that can be designed in accordance with an embodiment of the disclosure;

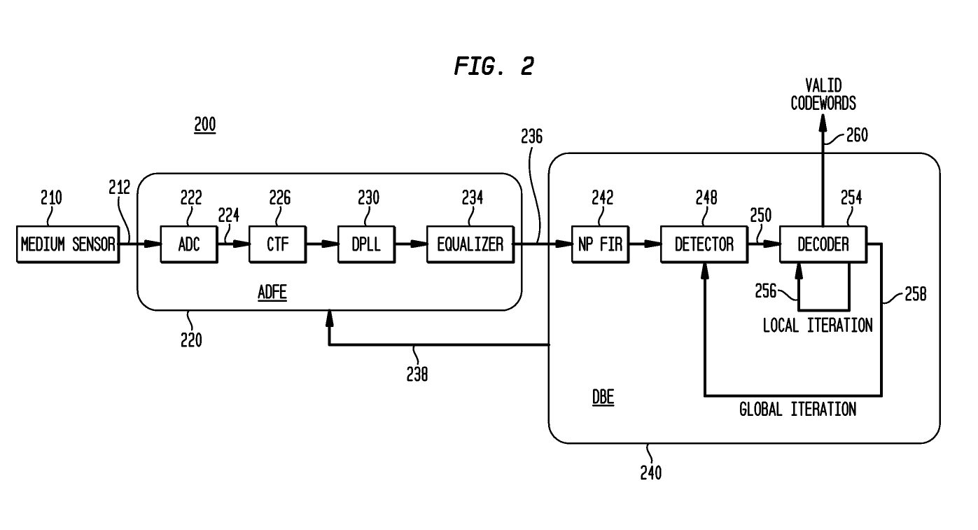

FIG. 2 shows a block diagram of a read channel that can be used to implement the read channel in the communication system shown in FIG. 1 according to one embodiment of the disclosure;

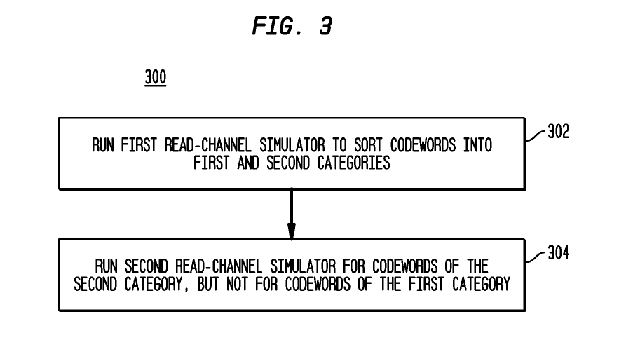

FIG. 3 shows a flowchart of a computer-aided design method that can be used to develop, simulate, refine, and test an implementation of the read-channel shown in FIG. 2 according to one embodiment of the disclosure;

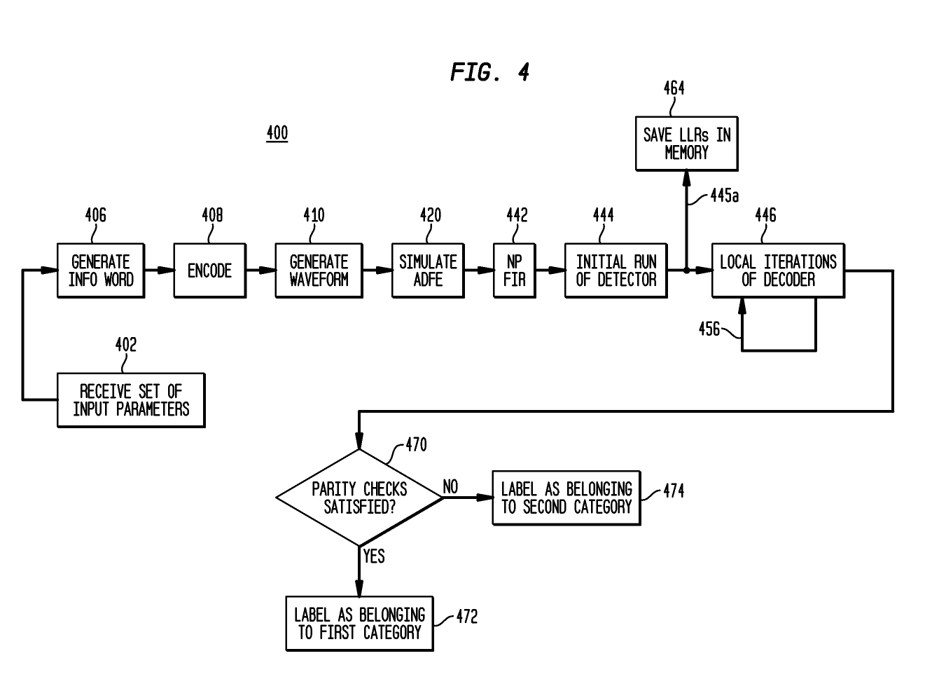

FIG. 4 shows a flowchart of a method of simulating a read-channel that can be used to implement a first read-channel simulator in the computer-aided design method shown in FIG. 3 according to one embodiment of the disclosure;

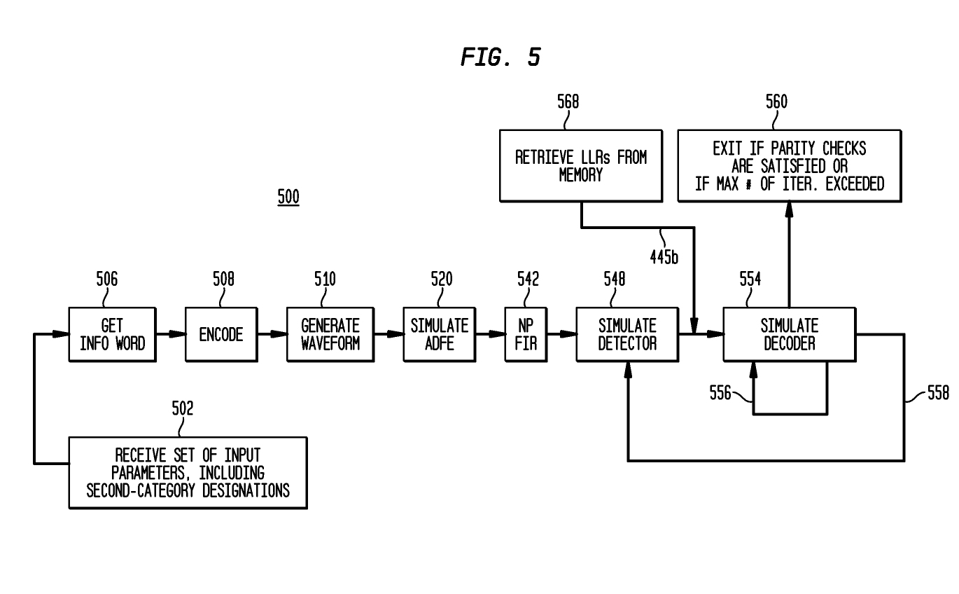

FIG. 5 shows a flowchart of a method of simulating a read-channel that can be used to implement a second read-channel simulator in the computer-aided design method shown in FIG. 3 according to one embodiment of the disclosure; and

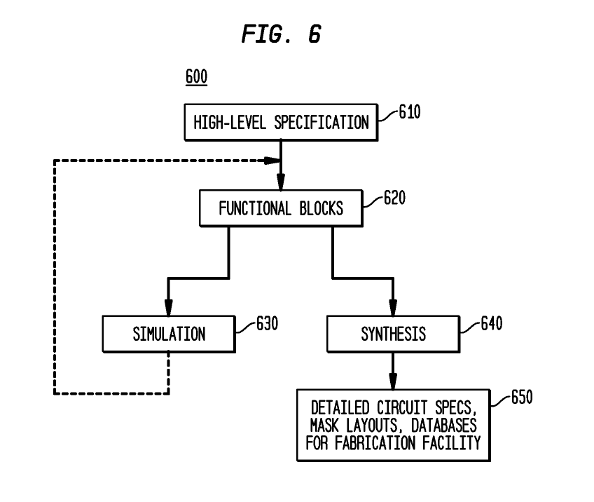

FIG. 6 shows a flowchart of a method of designing an integrated circuit in which various embodiments of the computer-aided design method shown in FIG. 3 can be practiced.

In particular, FIG. 1 shows a block diagram of a communication system 100 having a write channel 102 and a read channel 104. Disposed between write channel 102 and read channel 104 is a storage medium 140 (e.g., a flash drive, a hard-drive platter, etc.) configured to receive data from the write channel for storage therein and make the stored data available for retrieval through the read channel. System 100 has a system controller 150 that controls the operations of write channel 102, read channel 104, and storage medium 140. In one embodiment, controller 150 is an ARM (Advanced RISC (reduced instruction-set code) Machine) processor.

In one embodiment, write channel 102 comprises a data source (e.g., input port) 110, a low-density parity-check (LDPC) encoder 120, and a write processor 130. In operation, data source 110 provides a set of bits 112, often referred to as an original information word, to LDPC encoder 120. LDPC encoder 120 encodes original information word 112 using an LDPC code to generate an original codeword 122, often referred to as the channel-input codeword. LDPC encoding is known in the art and is described in more detail, e.g., in International Patent Application Publication No. WO 2010/019168, which is incorporated herein by reference in its entirety. Original codeword 122 is supplied to write processor 130, which converts it into an appropriate write signal 132 and applies the write signal to storage medium 140. Write signal 132 controllably alters the state of storage medium 140, thereby causing original codeword 122 to be stored in the storage medium.

In one embodiment, read channel 104 comprises a channel detector 160, a decoding and post-processing (DPP) unit 170, and a data destination (e.g., output port) 180. To retrieve original codeword 122 from storage medium 140, channel detector 160 senses the corresponding location(s) in the storage medium to obtain a read signal 142. Channel detector 160 then converts read signal 142 into a corresponding set of log-likelihood-ratio (LLR) values 162 and supplies said LLR values to DPP unit 170.

In one implementation, an LLR value comprises (i) a sign bit that represents the detector's best guess (hard decision) regarding the bit value stored at the corresponding sensed location in storage medium 140 and (ii) one or more magnitude bits that represent the detector's confidence in the hard decision. For example, channel detector 160 may output each LLR value as a five-bit value, where the most-significant bit is the sign bit and the four least-significant bits are the confidence bits. By way of example and not limitation, a five-bit LLR value of 00000 indicates a hard decision of 0 with minimum confidence, while a five-bit LLR value of 01111 indicates a hard decision of 0 with maximum confidence. Intermediate values (e.g., between 0000 and 1111) of confidence bits represent intermediate confidence levels. Similarly, a five-bit LLR value of 10001 indicates a hard decision of 1 with minimum confidence, while a five-bit LLR value of 11111 indicates a hard decision of 1 with maximum confidence, wherein the binary value of 10000 is unused. Other numbers of bits and other representations of confidence levels may also be used.

DPP unit 170 performs LDPC decoding on LLR values 162, which, if necessary, is followed by the application of one or more post-processing methods. More specifically, DPP unit 170 is configured to apply PP methods when the LDPC-decoding process fails, meaning, e.g., that, after the maximum allotted number of iterations, the output word of the LDPC decoder (not explicitly shown in FIG. 1) still has one or more unsatisfied parity checks. Depending on the actual number of unsatisfied parity checks, DPP unit 170 might (1) send a request to channel controller 150 to have channel detector 160 reread the corresponding location(s) in storage medium 140 and then repeat the decoding process for the newly received LLR values 162 or (2) alter the input to the LDPC decoder and restart the LDPC iterations with the altered input, but without a reread.

DPP unit 170 typically uses the first option when the output vector of the failed LDPC decoder has a relatively large number (e.g., more than about sixteen) of unsatisfied parity checks. DPP unit 170 typically uses the second option when the output vector of the failed LDPC decoder has a relatively small number of unsatisfied parity checks. After the LDPC decoder converges on a valid codeword, DPP unit 170 converts this codeword into the corresponding original information word and directs said word, via an output signal 172, to data destination 180.

FIG. 2 shows a block diagram of a read channel 200 that can be used to implement read channel 104 (FIG. 1) according to one embodiment of the disclosure. Read channel 200 is shown as having three constituent modules: a storage-medium sensor 210, an analog-to-digital front end (ADFE) 220, and a digital back end (DBE) 240. A brief description of how each of these modules operates is given below. For illustration purposes, read channels 104 and 200 are described in reference to LDPC codes. One of ordinary skill in the art will appreciate that read channels 104 and 200 can also be designed/configured to use other types of error-correction codes, such as turbo-codes that are non-LDPC codes.

Sensor 210 is configured to (i) access various locations of the corresponding storage medium, such as storage medium 140 (FIG. 1); (ii) sense the state(s) of the physical carrier of information used therein; and (iii) generate a corresponding electrical signal 212 that represents the sensed state(s) of the physical carrier. For example, in one embodiment, sensor 210 can be a magnetic read head in a disk drive configured to move above the corresponding magnetic-disk platter and transform the platter's magnetic-field pattern into electrical current, thereby generating signal 212.

ADFE 220 has an analog-to-digital converter (ADC) 222 that converts signal 212 into a corresponding electrical digital signal 224 and applies the latter signal to a series of configurable filters comprising a continuous-time filter (CTF) 226, a digital phase-lock loop (DPLL) 230, and a waveform equalizer 234. CTF 226 operates to modify the frequency content of signal 224 in a specified manner that is beneficial to the subsequent signal processing. For example, CTF 226 may be configured to remove a dc component (if any) from signal 224 and attenuate certain frequencies dominated by noise or interference. DPLL 230 operates to extract a clock signal from the signal it receives from CTF 226. The extracted clock signal can then be used to more optimally sample the received signal for processing. Waveform equalizer 234 operates to adjust waveform shapes in the signal it receives from DPLL 230 to make them closer to optimal waveform shapes, the latter being the waveform shapes for which DBE 240 is designed and calibrated. The respective configurations of CTF 226, DPLL 230, and waveform equalizer 234 can be adjusted using a feedback signal 238 generated by DBE 240 based on the signal processing implemented therein. In one embodiment, feedback signal 238 may carry an error metric that can be used to dive an error-reduction algorithm for appropriately configuring waveform equalizer 234. A description of possible alternative embodiments of feedback signal 238 can be found, e.g., in U.S. Pat. Nos. 7,734,981 and 7,889,446, both of which are incorporated herein by reference in their entirety.

DBE 240 includes a noise-predictive (NP) finite-impulse-response (FIR) equalizer 242, a sequence detector 248, and an LDPC decoder 254. NP-FIR equalizer 242 operates to reduce the amount of data-dependent, correlated noise in an output signal 236 generated by ADFE 220. Sequence detector 248 implements maximum-likelihood sequence estimation (MLSE) using a suitable MLSE algorithm, such as a Viterbi-like algorithm. In one embodiment, sequence detector 248 may operate to (i) emulate signal distortions, such as linear inter-symbol interference (ISI), in the preceding portion of read channel 200; (ii) compare the actual signal received from NP-FIR equalizer 242 with an anticipated distorted signal; and (iii) deduce the most likely stored bit sequence based on said comparison. An output signal 250 generated by sequence detector 248 contains a sequence of LLR values that represent the detector's confidence in the correctness of the deduced bit sequence.

Decoder 254 operates to convert the sequence of LLR values received via signal 250 into a corresponding valid codeword. A valid codeword is characterized in that all its parity checks defined by the code's parity-check matrix are satisfied (e.g., produce zeros). Therefore, decoder 254 first calculates the parity checks. If all parity checks are satisfied, then the decoding process is terminated, and decoder 254 outputs the codeword that satisfied the parity checks via an output signal 260. If some of the parity checks are not satisfied, then decoder 254 tries to converge on a valid codeword using an iterative process indicated in FIG. 2 by a looped arrow 256. In one embodiment, iterative process 256 is based on a message-passing or belief-propagation algorithm. After each iteration 256, decoder 254 recalculates the parity checks and, depending on the result, may either output a valid codeword via output signal 260 or proceed to perform another iteration 256.

If decoder 254 fails to converge on a valid codeword, e.g., after a specified maximum number of iterations 256, then the decoding process is temporarily halted, and the signal processing is directed back to detector 248 as indicated by a return arrow 258. Based on certain characteristics of the failed decoding process in decoder 254, the settings of sequence detector 248 are appropriately adjusted. Using the adjusted settings, sequence detector 248 regenerates the sequence of LLR values and provides the regenerated sequence to decoder 254 via signal 250. Decoder 254 then restarts the halted decoding process, now using the regenerated sequence of LLR values.

If detector 248 and decoder 254 fail to converge on a valid codeword, e.g., after a specified maximum number of restarts (global iterations), then the decoding process is terminated. In some configurations of read channel 200, after the decoding process has been terminated, a request may be sent to the channel controller (e.g., channel controller 150, FIG. 1) to initiate a reread of the corresponding piece of stored data from the storage medium (e.g., storage medium 140, FIG. 1). Alternatively or in addition, other post-processing options may be invoked to remedy the decoding-process failure.

FIG. 3 shows a flowchart of a computer-aided design method 300 that can be used to develop, simulate, refine, and test an implementation of read-channel 200 according to one embodiment of the disclosure. Method 300 can, for example, be implemented as an add-on or plug-in module for a more-general computer-aided design and simulation tool. Method 300 can be embodied in the form of program code, stored in a non-transitory computer-readable storage medium such that, when the program code is loaded into and executed by a computer, the computer becomes an apparatus for carrying out method 300.

In one embodiment, method 300 is capable of testing, e.g., through simulation, a specific read-channel architecture proposed by the read-channel developer before implementing that architecture in an actual physical VLSI chip. Method 300 can be run multiple times with different parameter sets, e.g., to generate a family of BER curves that provide convenient means for comparing the performance of different encoding/decoding schemes and for selecting, e.g., an acceptable parity-check matrix H for use in the read-channel chip under development.

Method 300 starts at step 302, where a first read-channel simulator is run to sort codewords into first and second categories. In one implementation, the first read-channel simulator has the following characteristics: (i) sequence detector 248 and LDPC decoder 254 are simulated as having a limited functionality, e.g., as further explained below in reference to FIG. 4; (ii) the simulation of sequence detector 248 and LDPC decoder 254 is implemented in a manner that enables the simulation to be run on a parallel computing device, such as a multiprocessor cluster, to speed up the sorting process; and (iii) the first read-channel simulator is configured to access a memory that can be shared with a second read-channel simulator, e.g., to enable efficient transfer of at least some LLR values generated by the first read-channel simulator for subsequent use in the second read-channel simulator.

The first read-channel simulator designates a codeword as belonging to the first category if the set of LLR values corresponding to that codeword is correctly decoded under the limited functionality of the simulated sequence detector 248 and LDPC decoder 254, which means that all parity checks defined by the operative parity-check matrix are satisfied (e.g., produce zeros) in the simulated LDPC decoder of the first read-channel simulator. The first read-channel simulator designates a codeword as belonging to the second category if the set of LLR values corresponding to that codeword cannot be correctly decoded with the limited functionality of the simulated sequence detector 248 and LDPC decoder 254. The sets of LLR values corresponding to the codewords of the second category can be saved in the shared memory for subsequent use in the second read-channel simulator. In contrast, the sets of LLR values corresponding to the codewords of the first category are not saved in the shared memory and may be discarded.

At step 304, the second read-channel simulator is run for the codewords of the second category, but not for the codewords of the first category. In one implementation, the second read-channel simulator has the following characteristics: (i) sequence detector 248 and LDPC decoder 254 are simulated as having an extended functionality, e.g., as they would have in a fabricated VLSI circuit embodying read channel 200 (FIG. 2); and (ii) the second read-channel simulator has access to the shared memory, e.g., to retrieve from it the LLR values saved therein by the first read-channel simulator.

An implementation of method 300 can advantageously reduce the simulation time compared to the time required for running a conventional simulation method for at least some of the following reasons. A modern read channel, such as read channel 104 (FIG. 1) or 200 (FIG. 2), typically generates a read signal, such as read signal 142 (FIG. 1), having a relatively high signal-to-noise ratio (SNR). This relatively high SNR causes the read channel to decode most portions of the read signal corresponding to different respective codewords without any global iterations, such as those indicated by return arrow 258 in FIG. 2. Only the decoding processing corresponding to very few codewords invokes the full functionality of the sequence detector and LDPC decoder, such as sequence detector 248 and LDPC decoder 254 (FIG. 2). Relying on this property of modern read channels, an implementation of method 300 is able to reduce the simulation time, e.g., by (i) applying streamlined, efficiently implemented decoding processing to most codewords under the limited functionality of the first read-channel simulator; (ii) applying the relatively highly time-consuming decoding processing of the second read-channel simulator to only very few codewords based on the codeword sorting performed in the first read-channel simulator; and (iii) sometimes skipping some of the normally performed processing steps in the second read-channel simulator by recycling, through the shared memory, at least some of the LLR values generated by the first read-channel simulator.

FIG. 4 shows a flowchart of a method 400 of simulating a read-channel that can be used to implement step 302 (FIG. 3) according to one embodiment of the disclosure.

Execution of method 400 begins at processing block 402, where a set of input parameters is provided for the run. A representative set of input parameters may include, but is not limited to: (i) code bit density, CBD; (ii) an SNR value; (iii) waveform-generator settings; (iv) a seed value; and (v) encoder/decoder settings. More specifically, a CBD value is a parameter that describes how densely the different domains that represent bits of information on the actual physical carrier are packed with respect to one another. For example, a CBD value can be expressed as a ratio of a FWHM (full width at half maximum) of a magnetic-field pulse carried by a representative magnetic domain to an average distance between neighboring magnetic domains. The SNR value and the waveform-generator settings enable method 400 to simulate signal 212 (FIG. 2), e.g., in terms of the absolute and relative contribution of various types of noise, such as white noise, jitter, colored noise, etc. The seed value may be used in the generation of codewords, which are then used for the performance simulation/evaluation of read channel 200 during the corresponding runs of method 400. The specific decoder settings may include an exact form of parity-check matrix H to be tested.

At processing block 406, method 400 generates one or more information words u for use in the subsequent processing blocks. Processing block 406 is generally configured to simulate the operation of a data source, such as data source 110 (FIG. 1).

At processing block 408, the one or more information words u received from processing block 406 are converted into the corresponding one or more codewords e. Processing block 408 is generally configured to simulate the operation of an encoder, such as LDPC encoder 120 (FIG. 1). In various configurations of method 400, processing block 408 can operate in a regular operating mode or in a coset mode.

In a regular operating mode, processing block 408 generates codeword e from a corresponding original information word u in accordance with Eq. (1):

e=Gu (1)

where e is a binary vector of length n; u is a binary vector of length k; and G is the n×k generator matrix, which satisfies the condition of uGH=0 for any original information word u, where n>k are both positive integers, and H is the parity-check matrix specified in the decoder settings of processing block 402. Since Eq. (1) depends on generator matrix G, a regular-operating-mode encoding process implicitly depends on parity-check matrix H.

In a coset mode, processing block 408 generates codeword e from a corresponding original information word u in accordance with Eq. (2):

e=u∥r (2)

where “∥” denotes concatenation; and r is a pseudo-random binary vector of length (n−k). Vector r is unequivocally defined by a corresponding “seed value,” which is specified at processing block 402 as part of the input set of simulation parameters. More specifically, when provided with a specific seed value, a pseudo-random sequence generator generates vector r in a deterministic manner. Since Eq. (2) does not depend on generator matrix G, a coset-mode encoding process does not depend on and is not a function of parity-check matrix H.

At processing block 410, the one or more codewords e received from processing block 408 are converted into the corresponding one or more waveforms. The conversion is performed based on the waveform-generator settings received at processing block 402. Processing block 410 is generally configured to simulate the digitized output of a storage-medium sensor, such as electrical digital signal 224 generated by sensor 210 and ADC 222 (see FIG. 2).

At processing block 420, the one or more waveforms received from processing block 410 are digitally filtered to generate the corresponding one or more filtered waveforms. Processing block 420 is generally configured to simulate the operation of configurable digital filters in an ADFE, such as CTF 226, DPLL 230, and waveform equalizer 234 in ADFE 220 (see FIG. 2).

At processing block 442, the one or more filtered waveforms received from processing block 420 are subjected to digital equalization to generate the corresponding one or more equalized waveforms. Processing block 442 is generally configured to simulate the operation of an NP-FIR equalizer, such as NP-FIR equalizer 242 (FIG. 2).

Processing blocks 444 and 446 are generally configured to simulate the operation of a sequence detector and an LDPC decoder, respectively, such as sequence detector 248 and LDPC decoder 254 in read channel 200 (see FIG. 2). As indicated above, the simulation implemented in processing blocks 444 and 446 is performed in a manner that limits the functionality of the simulated sequence detector and LDPC decoder. For example, in read channel 200, sequence detector 248 and LDPC decoder 254 can perform multiple iterations/restarts while attempting to converge on a valid codeword. In contrast, processing blocks 444 and 446 do not permit any feedback from the latter processing block to the former processing block and, as such, do not permit any global restarts of the decoding process, such as those indicated by arrow 258 in FIG. 2. In addition, the maximum number of local iterations 456 in processing block 446 may be set to a relatively low value, e.g., significantly smaller than a value that would be used in a fabricated VLSI circuit embodying read channel 200 (FIG. 2).

Processing block 444 is configured to simulate an initial run of the sequence detector. An output of processing block 444 is an LLR set 445a, which is provided to processing block 446 for further processing and is also saved in a memory (if necessary, along with the corresponding codeword e) by executing processing block 464. In a regular operating mode, LLR set 445a implicitly depends on parity-check matrix H. In a coset mode, LLR set 445a does not depend on parity-check matrix H.

Processing block 446 is configured to simulate local iterations of the LDPC decoder, such as decoder 254 in read channel 200 (FIG. 2). As such, processing block 446 attempts to convert LLR set 445a into a corresponding valid codeword e. A valid codeword is characterized in that all its parity checks defined by parity-check matrix H are satisfied. Therefore, processing block 446 first calculates the parity checks in accordance with Eq. (3):

He=s (3)

where s is a syndrome. In a regular operating mode, syndrome s is a zero vector (i.e., a vector whose components are all zeros). In a coset mode, syndrome s is a non-zero vector (i.e., has at least one non-zero component). To enable, non-zero-syndrome-based decoding, the simulated decoder can calculate, for each codeword e and parity-check matrix H, the corresponding syndrome s, e.g., using the a priori knowledge of the codeword from processing block 408.

If all parity checks are satisfied, then the processing of method 400 is transferred from processing block 446 to processing block 470. If some of the parity checks are not satisfied, then processing block 446 tries to converge on a valid codeword using an iterative process that can be based, e.g., on a message-passing or belief-propagation algorithm. This iterative process is indicated in FIG. 4 by a looped arrow 456. After each iteration 456, processing block 446 recalculates the parity checks defined by Eq. (3) and, depending on the result, may either transfer the processing to processing block 470 or proceed to perform another iteration 456. As already indicated above, the maximum number of iterations 456 is set to a relatively small value. If that number is reached without convergence on a valid codeword, then no further iterations are permitted in processing block 446, and the processing is transferred to processing block 470.

Processing blocks 470, 472, and 474 implement the sorting of various codewords e into the first and second categories based on the respective decoding results achieved in processing block 446. More specifically, if processing block 446 was able to successfully recover a codeword, then that codeword is labeled as belonging to the first category at processing block 472. If processing block 446 was not able to recover a codeword, then that codeword is labeled as belonging to the second category at processing block 474.

Method 400 may be particularly beneficial, e.g., when one needs to compare several different turbo decoders having the same implementation/configuration of the detector module, but configured to use different respective parity-check matrices H in the decoder module. Since LLR set 445a does not depend on parity-check matrix H when a coset mode is used, the upstream processing that feeds processing block 446 need not be repeated for testing different parity-check matrices H. Instead, for each codeword e, the corresponding LLR set 445a can be fed into several copies of processing block 446 running in parallel, with each copy being configured to use a different respective parity-check matrix H. In this manner, codeword classifications can be generated for multiple variants of the turbo decoder in the amount of time essentially corresponding to a single pass through method 400.

The use of a coset mode may also be beneficial, e.g., when the processing implemented in processing block 444 takes significantly more time than the processing implemented in processing block 446. In this case, method 400 can be configured to serially call several variants of the simulated turbo decoder using the respective, appropriately configured copies of processing block 446 and, at the same time, run the upstream processing (e.g., processing blocks 402-444) corresponding to the next codeword, thereby pipelining the processing corresponding to different codewords and different parity-check matrices H.

FIG. 5 shows a flowchart of a method 500 of simulating a read-channel that can be used to implement step 304 (FIG. 3) according to one embodiment of the disclosure. As such, method 500 is invoked only for the codewords that were labeled as belonging to the second category at step 302 of method 300 (FIG. 3) or in method 400 (FIG. 4). In general, method 500 is designed to use different (e.g., more sophisticated/complicated/precise) processing algorithms than method 400. For example, the following is a non-exhaustive list of differences, one or more of which may be present when methods 400 and 500 are used to implement steps 302 and 304, respectively, of method 300:
(1) Method 500 permits both local and global iterations of the simulated detector/decoder pair, as indicated by looped arrows 556 and 558 in FIG. 5. In contrast, method 400 does not permit global iterations, as indicated by the absence of a looped arrow analogous to arrow 558 in FIG. 4;
(2) Simulated decoder 554 in method 500 is allowed to perform more local iterations 556 before the corresponding processing is terminated than the maximum number of local iterations 456 allowed in simulated decoder 454 in method 400; and
(3) The steps in each pair of functionally analogous steps in methods 400 and 500 (e.g., designated with the labels having the same last two digits) can be implemented using different respective processing algorithms.

The presence of one or more of the above-listed differences could make it virtually certain that method 500 would be able to converge on a valid codeword of the first category, e.g., because the generally less-powerful method 400 was able to converge on the corresponding valid codeword. This observation provides a justification for applying method 500 only to the codewords of the second category, and not to the codewords of the first category. The latter saves valuable processing time and may advantageously accelerate the read-channel development process as a whole.

For example, at relatively high SNR values, the bit error rate is relatively low (for example, about 10⁻¹²), which causes the second category to contain very few codewords. Moreover, at relatively high SNR values, for the majority of the codewords, the decoding process converges after a single global iteration. This means that method 400 can model the system behavior reasonably well for most codewords, and also that the simulation method itself is not the cause of the number of global iterations being so low. In addition, the average number of local iterations is very small as well, for example, about two, which means that most simulation time (e.g., close to 90% of the total) is taken up by processing step 444 or its analog. Since this step can be excluded in method 500 for most of the codewords, a combination of methods 400 and 500, e.g., as shown at FIG. 3, can save close to 90% of simulation time for those codewords.

Processing block 502 is generally analogous to processing block 402 (FIG. 4) in terms of the input parameters that are being received thereat. However, in addition, processing block 502 relies on the codeword classification produced at step 302 of method 300 (FIG. 3) or in method 400 (FIG. 4) to cause the application of method 500 only to the codewords of the second category. For example, if a set of input parameters received at processing block 502 includes a seed value corresponding to a codeword of the first category, then this set is not admitted for processing, and a next set of input parameters is considered for admission. However, if a set of input parameters received at processing block 502 includes a seed value corresponding to a codeword of the second category, then the set is admitted for processing using method 500.

Processing blocks 506, 508, 510, 520, and 542 in method 500 are generally analogous to processing blocks 406, 408, 410, 420, and 442, respectively, in method 400. However, as indicated above, processing blocks 506, 508, 510, 520, and 542 in method 500 may be implemented using different (e.g., more sophisticated, complicated, and/or precise) processing algorithms than those used in their counterparts blocks in method 400. In one possible configuration, the processing corresponding to processing blocks 506, 508, 510, 520, and 542 can be skipped altogether, along with the initial run of simulated detector 548. Instead of these processing blocks and the initial detector run, method 500 can execute processing block 568, which causes a copy 445b of an appropriate LLR set 445a (see FIG. 4) to be retrieved from the memory for use in processing block 554.

Processing blocks 548 and 554 are generally configured to simulate the operation of a sequence detector and an LDPC decoder, respectively, such as sequence detector 248 and LDPC decoder 254 (FIG. 2). The decoding process is terminated at processing block 560 either when the multiplication of parity-check matrix H by the codeword deduced by the LDPC decoder from the corresponding set of LLR values (which can be LLR set 445b or an LLR set generated by processing block 548) satisfies Eq. (3) or when the number of global iterations 558 reaches a specified threshold value. A failure to converge on a valid codeword is generally interpreted as a decoding error. The decoding errors that occur during different runs of method 500 may be counted, e.g., to estimate a BER in the read channel that is being simulated.

FIG. 6 shows a flowchart of a method 600 of designing an integrated circuit in which various embodiments of methods 300 (FIG. 3), 400 (FIG. 4), and 500 (FIG. 5) can be practiced. In one embodiment, method 600 is a relatively general computer-aided design and simulation tool that can be used to develop, simulate, synthesize, and produce various types of integrated circuits, including but not limited to read channel 200 (FIG. 2). Various embodiments of methods 300 (FIG. 3), 400 (FIG. 4), and 500 (FIG. 5) can be used in method 600, e.g., to implement step 630.

In general, a modern integrated circuit is designed by humans (e.g., one or more electrical engineers) to be built by machines at a fabrication facility. Hence, method 600 acts as a translator between the human designers and the fabricating machines. More specifically, a CAD system running method 600 has (i) a human interface, e.g., graphical and/or textual, that enables a designer to direct the design process toward a desired outcome and (ii) a generator of digital specifications, layouts, and/or databases that can be used to program the various machines at the fabrication facility.

At step 610 of method 600, the integrated circuit that is being designed is described in terms of its overall behavior. One of the goals of this step is to produce high-level technical specifications that will result in a product that fulfills an intended purpose.

At step 620, the design at the behavioral level is elaborated in terms of functional blocks. The behavior of each functional block is usually detailed, but the description of the functional block still remains at a relatively abstract level, e.g., without detailing its internal circuit structure to the level of individual circuit elements, such as gates, switches, etc. The interaction of different functional blocks with one another is properly specified in accordance with the intended overall function of the integrated circuit.

At step 630, the circuit architecture produced at step 620 is tested through a simulation process. Simulation is typically carried out using a set of dedicated simulation tools, e.g., including but not limited to those embodying methods 300, 400, and 500. With every simulation run, the obtained simulation results are studied and analyzed to identify non-optimal behaviors and/or design flaws/errors. Simulation tools can also be used to compare the performance of different versions/configurations of the same circuit. Steps 620 and 630 are usually repeated in a cyclic iterative process (indicated in FIG. 6 by the dashed arrow) until error-free and/or optimal circuit architecture and configuration are obtained.

At step 640, the circuit architecture and configuration obtained by repeating steps 620 and 630 is converted into a corresponding hardware realization. Two often-used approaches here are: (1) to realize the circuit using an FPGA or (2) to realize the circuit as an ASIC. An FPGA route may be more attractive for limited-volume production and/or for a short-development cycle. In various embodiments, step 640 may include one or more of the following sub-steps: selecting circuit components from a library or an FPGA, floor planning, placement, routing, and post-layout simulation. Some of the sub-steps of step 640 may have to be carried out iteratively to yield acceptable results.

At step 650, a final set of detailed circuit specifications, mask layouts, and/or databases is generated based on the results of step 640. These items are then transferred to a fabrication facility to enable fabrication of the integrated circuit thereat.

While various embodiments of the invention have been described herein, the descriptions are not intended to be construed in a limiting sense. Various modifications of the described embodiments, as well as other embodiments of the invention, which are apparent to persons skilled in the art to which the invention pertains are deemed to lie within the invention as expressed in the following claims.

Unless explicitly stated otherwise, each numerical value and range should be interpreted as being approximate as if the word “about” or “approximately” preceded the value of the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Embodiments of the invention can be manifest in other specific apparatus and/or methods. The described embodiments are to be considered in all respects as only illustrative and not restrictive. All changes that come within the meaning and range of equivalency of the claims are to be embraced within their scope.

A person of ordinary skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as magnetic disks or tapes, hard drives, or optically readable digital data storage media. The embodiments are also intended to cover computers programmed to perform said steps of methods described herein.

The description and drawings merely illustrate embodiments of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding an embodiment of the invention and the concepts contributed by the inventor(s) to furthering the art, and are to be construed as being without limitation to such specifically recited examples and conditions. Moreover, all statements herein reciting embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “computer,” “processor,” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

It should be appreciated by those of ordinary skill in the art that any block diagrams herein represent conceptual views of illustrative circuitry embodying the principles of the invention. Similarly, it will be appreciated that any flowcharts, flow diagrams, state transition diagrams, pseudo code, and the like represent various processes which may be substantially represented in computer readable medium and so executed by a computer or processor, whether or not such computer or processor is explicitly shown.

What is claimed is:

1. A computer-aided design method comprising:
(A) sorting codewords into a first category and a second category by running a first computer-based read-channel simulator configured to simulate performance of a read channel, wherein:
the first category has codewords successfully decoded by the first read-channel simulator; and
the second category has codewords that the first read-channel simulator is unable to successfully decode; and
(B) simulating performance of said read channel by running a second computer-based read-channel simulator, different from the first read-channel simulator, for the codewords of the second category, but not for the codewords of the first category.

2. The method of claim 1, wherein:
said read channel has a sequence detector and a turbo-decoder;
the first read-channel simulator is configured to simulate the performance of the read channel without feedback from the turbo-decoder to the sequence detector; and
the second read-channel simulator is configured to simulate the performance of the read channel wherein the turbo-decoder is configured to provide feedback to the sequence detector for a next decoding iteration.

3. The method of claim 2, wherein:
in the first read-channel simulator, the turbo-decoder is simulated as being configured not to exceed a first number of decoding iterations;
in the second read-channel simulator, the turbo-decoder is simulated as being configured not to exceed a second number of decoding iterations; and
the second number is greater than the first number.

4. The method of claim 2, wherein the turbo-decoder is a low-density parity-check decoder.

5. The method of claim 1, wherein:
said read channel has a turbo-decoder;
in the first read-channel simulator, the turbo-decoder is simulated as being configured not to exceed a first number of decoding iterations;
in the second read-channel simulator, the turbo-decoder is simulated as being configured not to exceed a second number of decoding iterations; and
the second number is greater than the first number.

6. The method of claim 1, wherein:
said read channel has a medium sensor;
step (A) comprises generating a first waveform that simulates an output of the medium sensor corresponding to a codeword of the second category, with said generating being performed using a first waveform-generating algorithm; and
step (B) comprises generating a second waveform that simulates the output of the medium sensor corresponding to said codeword of the second category, with said generating being performed using a second waveform-generating algorithm that is different from the first waveform-generating algorithm.

7. The method of claim 6, wherein:
said read channel further has an analog-to-digital front end coupled to the medium sensor;
step (A) further comprises digitally filtering the first waveform to generate a first filtered waveform, with said filtering being performed using a first waveform-filtering algorithm that simulates performance of the analog-to-digital front end; and
step (B) further comprises digitally filtering the second waveform to generate a second filtered waveform, with said filtering being performed using a second waveform-filtering algorithm that simulates performance of the analog-to-digital front end, wherein the second waveform-filtering algorithm is different from the first waveform-filtering algorithm.

8. The method of claim 7, wherein:
said read channel further has a sequence detector coupled to the analog-to-digital front end;
step (A) further comprises applying a first maximum-likelihood-sequence-estimation algorithm to the first filtered waveform to generate a first set of log-likelihood-ratio values, wherein said applying simulates performance of the sequence detector; and
step (B) further comprises applying a second maximum-likelihood-sequence-estimation algorithm to the second filtered waveform to generate a second set of log-likelihood-ratio values, wherein said applying simulates performance of the sequence detector, and the second maximum-likelihood-sequence-estimation algorithm is different from the first maximum-likelihood-sequence-estimation algorithm.

9. The method of claim 1, wherein:
said read channel has an analog-to-digital front end;
step (A) comprises digitally filtering a first waveform corresponding to a codeword of the second category to generate a first filtered waveform, with said filtering being performed using a first waveform-filtering algorithm that simulates performance of the analog-to-digital front end; and
step (B) comprises digitally filtering a second waveform corresponding to said codeword of the second category to generate a second filtered waveform, with said filtering being performed using a second waveform-filtering algorithm that simulates performance of the analog-to-digital front end, wherein the second waveform-filtering algorithm is different from the first waveform-filtering algorithm.

10. The method of claim 1, wherein:
said read channel has a sequence detector;
step (A) comprises applying a first maximum-likelihood-sequence-estimation algorithm to a first waveform corresponding to a codeword of the second category to generate a first set of log-likelihood-ratio values, wherein said applying simulates performance of the sequence detector; and
step (B) comprises applying a second maximum-likelihood-sequence-estimation algorithm to a second filtered waveform corresponding to said codeword of the second category to generate a second set of log-likelihood-ratio values, wherein said applying simulates performance of the sequence detector, and the second maximum-likelihood-sequence-estimation algorithm is different from the first maximum-likelihood-sequence-estimation algorithm.

11. The method of claim 10, wherein:
said read channel further has a turbo-decoder coupled to the sequence detector; and
step (A) further comprises:
(A1) simulating performance of the turbo-decoder in decoding the first set of log-likelihood-ratio values, wherein the turbo-decoder is configured to use a first parity-check matrix; and
(A2) simulating performance of the turbo-decoder in decoding the first set of log-likelihood-ratio values, wherein the turbo-decoder is configured to use a second parity-check matrix that is different from the first parity-check matrix; and

12. The method of claim 11, wherein steps (A1) and (A2) are executed in parallel.

13. The method of claim 11, wherein:
step (A) further comprises generating the codeword by concatenating an information word and a pseudo-random bit sequence;
step (A1) comprises:
generating a first syndrome vector by multiplying the first parity-check matrix and the codeword; and
simulating the decoding of the first set of log-likelihood-ratio values based on the first parity-check matrix and the first syndrome vector; and
step (A2) comprises:
generating a second syndrome vector by multiplying the second parity-check matrix and the codeword; and
simulating the decoding of the first set of log-likelihood-ratio values based on the second parity-check matrix and the second syndrome vector.

14. The method of claim 13, wherein at least one of the first and second syndrome vectors has at least one non-zero component.

15. The method of claim 1, wherein the read channel is adapted to read data saved on a magnetic disk platter.

16. The method of claim 1, further comprising:
(C) generating a database based on results of the simulated performances of steps (A) and (B) to enable a fabrication facility to fabricate an integrated circuit embodying the read channel.

17. The integrated circuit fabricated using the database of claim 16.

18. A database for fabricating an integrated circuit generated based on results of the simulated performances of steps (A) and (B) of claim 1.

19. An integrated circuit fabricated based on results of the simulated performances of steps (A) and (B) of claim 1.

20. A non-transitory machine-readable medium, having encoded thereon program code, wherein, when the program code is executed by a machine, the machine implements a computer-aided design method, the computer-aided design method comprising:
(A) sorting codewords into a first category and a second category by running a first computer-based read-channel simulator configured to simulate performance of a read channel, wherein:
the first category has codewords successfully decoded by the first read-channel simulator; and
the second category has codewords which the first read-channel simulator is unable to successfully decode; and
(B) simulating performance of said read channel by running a second computer-based read-channel simulator for the codewords of the second category, but not for the codewords of the first category.
